(19) United States
(12) Patent Application Publication
(10) Pub. No.: US 2004/0197036 A1
(43) Pub. Date: Oct. 7, 2004

(54) Traveller car

(76) Inventor: Geraint Pugh, Southampton (GB)

Correspondence Address: BURNS DOANE SWECKER & MATHIS L L P, POST OFFICE BOX 1404, ALEXANDRIA, VA, 22313-1404, US

(21) Appl. No.: 10/482,992

(22) PCT Filed: Jul. 10, 2002
(86) PCT No.: PCT/GB02/03199

(30) Foreign Application Priority Data
Jul. 13, 2001 (GB) 0117174.3

(51) Int. Cl. F16C 29/06

(52) U.S. Cl. 384/45

(57) ABSTRACT

A traveller car for a sailing vessel has recirculating rolling bearings for engaging its running tract (5). A return run of the rolling bearings is provided by a discrete tube (14) set in a body of the traveller car and passing through bores (15) in projections (16) from the body. Two arrays (7,8;9,10) of such bearings may be arranged in load-bearing relationship to each lateral side of the track.

The present invention relates to traveller cars. It is particularly, but not exclusively, related to traveller cars as used on marine craft and in particular on sailing vessels to control sails or other movable elements. Such devices are sometimes known as sliders, but the term “car” will be used throughout this specification.

Cars of this type are mounted on a track, and can move along that track. For example, the car for the mainsail of a sailing vessel, such as a yacht, is normally mounted on a lateral track near the stern of the vessel, and pulleys/blocks mounted on it receive the mainsheet from the boom. Similarly, cars running on longitudinal tracks may be used to adjust the foresail of a sailing vessel.

Frequently the car bears substantial loads, and it must be able to move freely along the track and not impede the movement of the boom or other equipment which is attached to it.

As a result, these cars are usually provided with low friction bearings, and in particular with caged rod bearings or with recirculating ball bearings. Recirculating ball bearings of an array of such bearings proceed around a closed loop, moving in one direction relative to the car when in contact with the track and the body of the car and in the opposite direction when returning out of contact with the track.

Sometimes the tracks are curved and various approaches have been adopted to accommodate the curvature of the track whilst maintaining the low friction requirement. These include having a multi-segment car with the segments articulated relative to each other, as proposed in GB 2322674A.

It is also desirable that the mass of the cars is kept as low as possible, as this not only has the effect of reducing the load on the contact bearings but also means that the car has less inertial resistance to moving along the track, and so more closely follows the movement of its load (e.g. the boom or foresail).

Therefore, according to a first aspect of the present invention, there is provided a traveller car for travel on a track, the car having a body, the body having a longitudinal slot for receiving the track; and recirculating rolling bearing elements for acting between the body and the track and arranged such that there are at least two arrays of said rolling bearing elements on each side of said slot for engagement with the track.

Conventional traveller cars which use recirculating bearings only have one loaded array of bearings on each side of the track. Adding a second load-bearing array of bearings on each side of the track allows the overall length of the car to be reduced without significantly increasing the pressure on each of the bearing elements. A shorter car has a number of advantages. It has less material overall, and therefore can be made lighter, which is an important factor in itself for racing vessels. The shorter car is less affected by the bending of the track and therefore runs more efficiently and can cope with a greater range of track bends (in particular tighter curves) under load. The shorter car also offers a greater range of travel along the track as the blocks or other means by which the load is attached to the car can get closer to the ends of the track.

A further advantage of the second array of bearings is that the car will be less liable to tilt when affected by forces perpendicular to the track.

In a second aspect of the invention, a traveller car for travel on a track has a body and the body has a longitudinal slot for receiving the track; and recirculating rolling bearing elements for acting between the body and the track arranged such that one run of an array of such bearings engages each side of the track, a return run of the said array proceeding through a tube or tubes which is or are an entity or entities discrete from the body. In a preferred embodiment a single tube per return run is arranged parallel to the track-engaging run of the recirculating bearings by penetrating a plurality of projections in the body. In this embodiment, recesses between the projections represent weight-saving reliefs in the body while the tube maintains a coherent path for the return run of the array of bearings.

In an alternative embodiment a single discrete tube per return run is arranged parallel to the track-engaging run of the recirculating bearings and is secured to the body at least at each end of the tube.

In a further preferred embodiment there are two such arrays of bearings on each side of the track.

In the body of the car of either aspect of the invention, the end of the track engaging and return runs of the recirculating rolling bearing element may be formed by an end cap of the body within which a U-shaped channel is formed to link the runs of the respective arrays; and in the car of either embodiment a shackle may be secured at a position in the body which is above the slot, preferably within a recess between projections of the body; and means for securing the shackle in position on the body may be accessible in a straight line from respective ends of the body.

Particular embodiments of the invention will now be described with reference to the accompanying drawings, wherein:

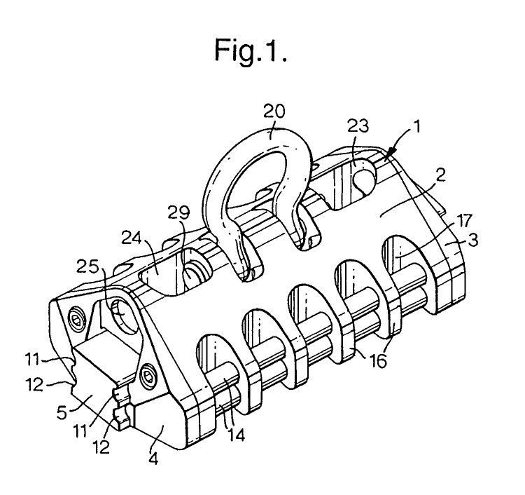

FIG. 1 is a perspective view of a first embodiment of traveller car assembled and mounted on a track;

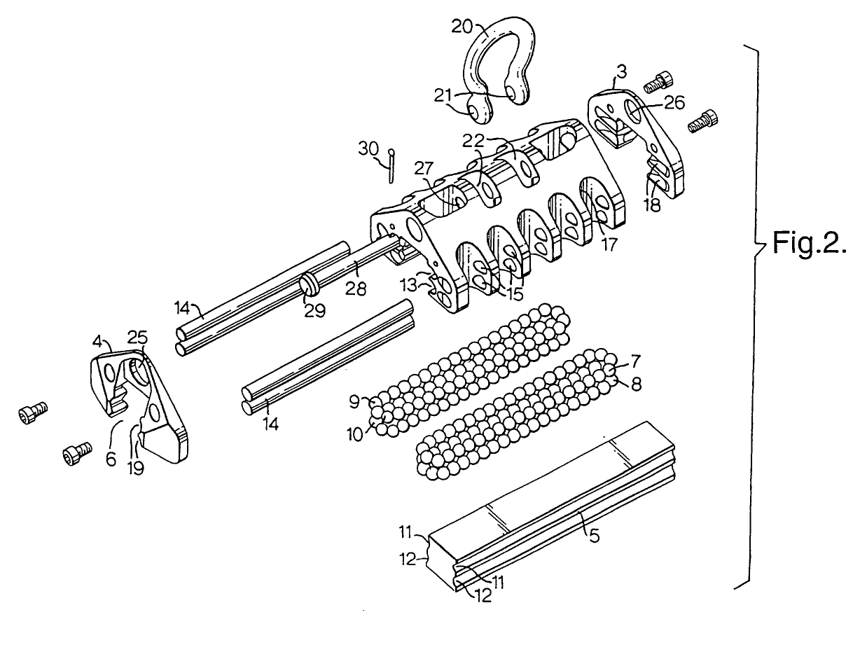

FIG. 2 is an exploded view of FIG. 1;

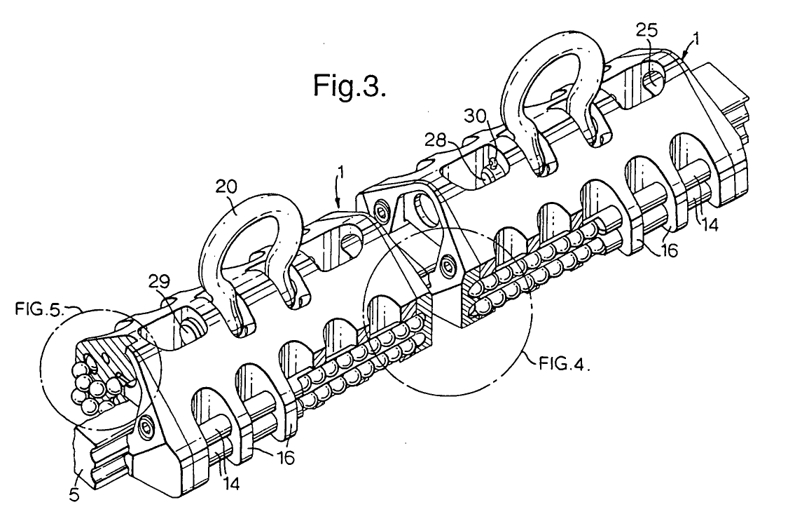

FIG. 3 is a perspective view of two such cars, partly cut away;

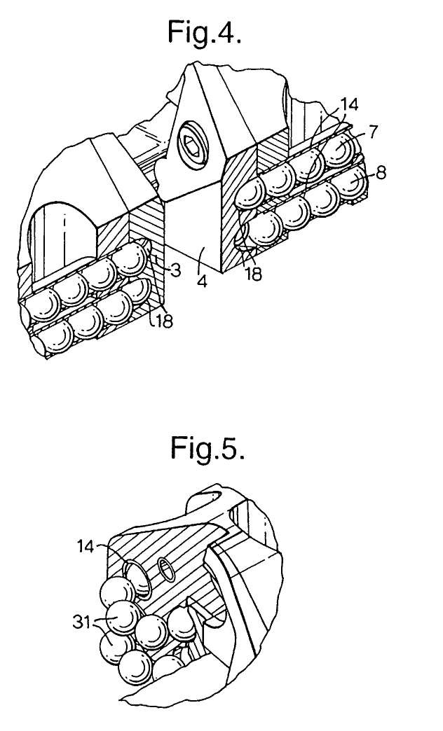

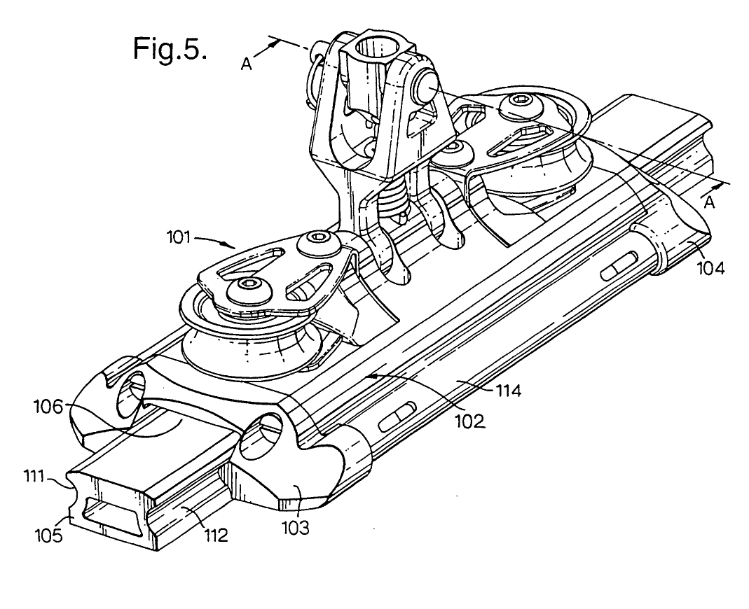

FIG. 4 is a detail at “FIG. 4” in FIG. 3; and FIG. 5 is a detail at “FIG. 5” in FIG. 3;

FIG. 5 is a perspective view of a second embodiment of traveller car assembled and mounted on a track;

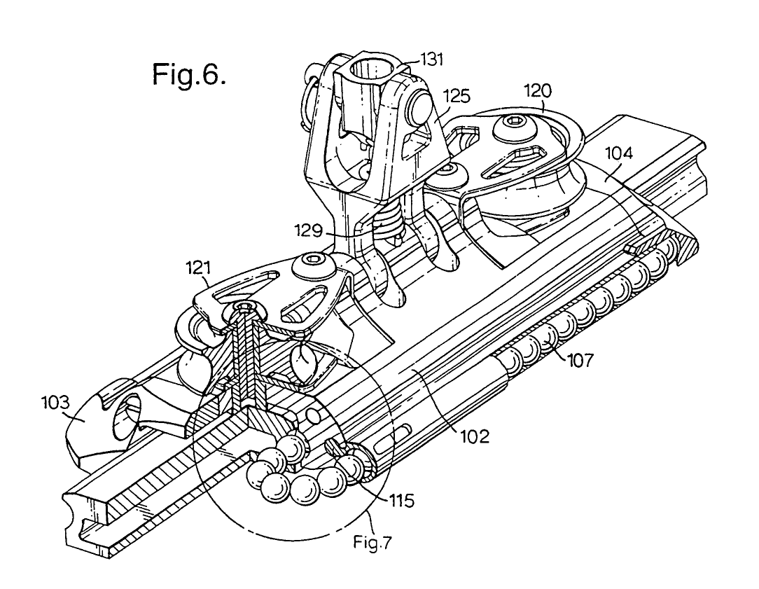

FIG. 6 is the same view as FIG. 5 but with parts cut away;

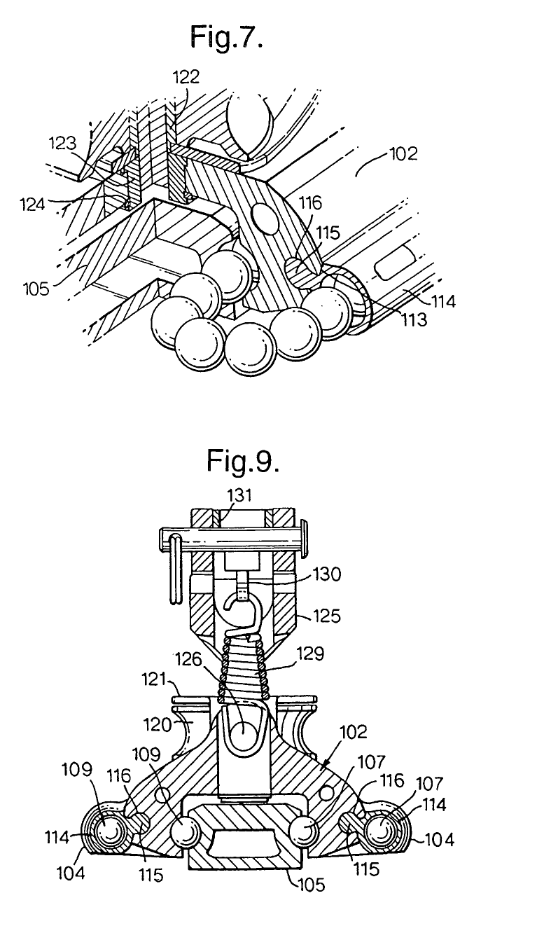

FIG. 7 is a detail at “FIG. 7” in FIG. 6;

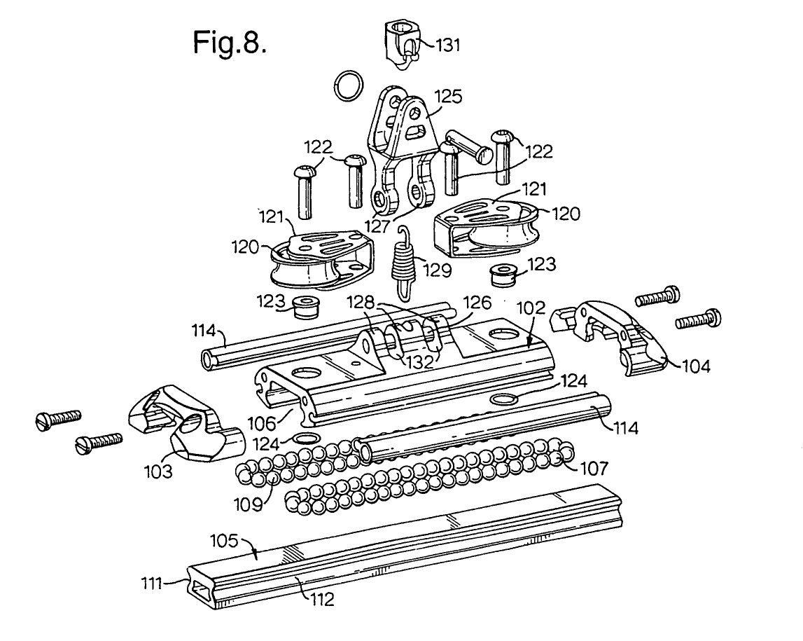

FIG. 8 is an exploded view; and

FIG. 9 is a sectional view in the plane A-A of FIG. 5.

Looking first at FIG. 1, a traveller car 1 for a yacht or similar sailing vessel has a body 2 which includes end caps 3 and 4. The body straddles a track 5 which may be mounted transversely or longitudinally of the sailing vessel.

The body has a slot 6 which enables it to straddle the track, and on each side of the track there are two arrays 7,8 on one side and 9,10 on the other of rolling contact bearings here shown as ballbearings.

One run of each of the arrays is in contact with the track 5 when the car is mounted on the track, and engage in shaped grooves 11,12 on the sides of the track. They run in grooves 13 in the wall of the slot 6 of the body.

A return run for each of the arrays 7-10 is provided by respective straight tubes 14 which are discrete entities inserted into the body, to run through registering aligned holes 15 in a series of fin-like projections 16 from each side of the body.

Between adjacent fin-like projection 16 is a relief 17 into the body, across which the tubes 14 bridge.

Thus, when the car moves on the track, the row of each array 8-10 of recirculating bearings in contact with the track will roll at half the speed of translation of the car in that direction and return in the opposite direction (relative to the body) through the tube.

This return is assured by the provision in the end caps 3,4 of scalloped grooves 18 which receive bearings from one run and direct them via a U-shaped turn 31 (FIG. 5) into the other.

The end caps 3,4 have projecting lugs 19 which extend into the grooves 11,12 of the track to protect the bearings from foreign matter as far as possible.

As can be seen, the provision of a double array of bearings on each side of the track diminishes the unit load on each contacting run and therefore enables the body of the car to be shorter than it would otherwise have needed to be, and furthermore the contact of two parallel runs of bearings on either side means there is greater resistance to twisting about the axis of the track when the car is subjected to off-centre loads.

Tension loads are conveyed to the car by means of a shackle 20 which is secured by eyelet lugs 21 in parallel recesses 22 in the top of the body. A line to a boom or sail can be engaged to the shackle. Along the top of the body there are reliefs 23,24 which have the purpose of lightening the body. In the end wall of the body and in each of the end caps 3 and 4 is an aperture 25,26 which are axially aligned with apertures 27 leading to the recesses 22, but are of greater diameter than the apertures 27.

Securing of the shackle to the body is by means of a pin 28 having an enlarged head 29 which can be passed freely through the apertures 25 or 26 but cannot be passed through apertures 27. The pin secures the eyelet lugs 21 to the body and is then itself secured by the positioning of split pin 30.

FIG. 3 shows in particular how two such cars 1 may be mounted on a track 5 (the left-hand end of which has been somewhat cut away in FIG. 3 for clarity of the detail which is in FIG. 5) and this illustrates how due to the reduced length of the body which is capable of being achieved, two such cars may be accommodated on a single track and each may more readily adapt to any curvature in the track.

The detail which is FIG. 4 shows individual bearings of the arrays 7 and 8 inside tubes 14 which are here diametrically cross-sectioned, and shows how they issue from the scalloped grooves 18 in the end caps 3,4 so as to transfer from one run of each array to the other.

The path followed within the scalloped grooves of the end caps is the U-shaped path 31 shown in FIG. 5. This embodiment may have a body without separate end caps, the transfer between runs being formed in an integral body part.

A second embodiment is seen in FIGS. 6 to 9. This has only one array of recirculating rolling bearing elements for engaging the respective lateral sides of the track, but could in the first embodiment have two at each side.

The second embodiment illustrates how different ways of securing the return run tubes can be used, which are applicable to embodiments having any number of arrays of rolling bearing elements.

In this embodiment, a car 101 has a body 102 with end caps 103,104. The body straddles a track 105 which as before may be mounted transversely or longitudinally of a sailing vessel. The body has a slot 106 which enables it to straddle the track and there is a single recirculating array of rolling contact bearings 107,109, at each lateral side of the track to act between the body and grooves 111 and 112 in respective lateral sides of the track.

Return runs of the arrays 107,109 pass through tubes 114 at respective sides of the body. The tubes are formed by extrusion to have a narrow-necked projection 115 along their length which, in fitting the tubes 114 to the body 102 is slid along a narrow-necked slot 116 of the body. The projection 115 is in a flattened outer face 113 of the tube. The tongue and groove engagement between projection 115 and slot 116 holds the flat face 113 of the tube securely against a face of the body and reinforces the tube against distortion while allowing the body to be constructed even more economically than in the first embodiment.

End caps 103,104 will be secured to the end of the body to overlap over the extreme ends of tubes 114 and offer, as in the first embodiment, a scalloped channel 118 for assuring transfer of the rolling bearing elements of the respective arrays 107,109 between their return and bearing runs as the car moves in either direction along the track.

This embodiment shows how pulleys 120 may be mounted in trunnion-like brackets 121 to an upper face of the body so as to receive lines which will be used to control the transverse movement of the car on the track, the brackets 121 being secured by penetration by bolts 122 which are secured in bushes 123 in apertures in the body secured by circlips 124 (FIG. 7).

Before the brackets are secured, shackle (also known as an “upstand”) 125 will have been secured in recesses 132 in the body by passage of a pin 126 in a straight line through registering apertures in legs 127 of the bracket and projections 128 from the body, the pin 126 at the same time securing one end of a spring 129 engaged with an eye 130 on a pivotally mounted socket part 131 at the head of the shackle for connection to a pulley block. The effect of the spring is to bias the shackle and the coupling 131 towards the vertical.

1. A traveller car for travel on a track, the car having a body, the body having a longitudinal slot for receiving the track, and there being recirculating rolling bearing elements for acting between the body and the track arranged such that there are at least two arrays of said rolling bearing elements on each side of said slot for engagement with the track.

2. A car according to claim 1, wherein an end of the track engaging and return runs of the recirculating rolling bearing elements is formed by an end cap of the body within which a U-shaped channel is formed to link the runs.

3. A traveller car for travel on a track, the car having a body, the body having a longitudinal slot for receiving the track, and there being recirculating rolling bearing elements for acting between the body and the track arranged such that at least one run of an array of such bearings engages each side of the track, a return run of the said array proceeding through a tube or tubes which is or are an entity or entities discrete from the body.

4. A car according to claim 1, wherein a single discrete tube per return run of rolling bearing elements is arranged parallel to the track-engaging run of the recirculating bearing elements by penetrating a plurality of projections in the body.

5. A car according to claim 1, wherein a single discrete tube per return run of rolling bearing elements is arranged parallel to the track-engaging run of the recirculating rolling bearing elements and is secured to the body at least at each end of the tube.

6. A car according to claim 1, wherein a single discrete tube per return run of rolling bearing elements is arranged parallel to the track-engaging run of the recirculating rolling bearing elements and is secured to the body by a tongue and groove engagement along the body.

7. A car according to claim 3, wherein the or each tube is straight and discrete end caps on the body have channels to guide the rolling bearing elements between a load bearing run and a return run.

8. A car according to claim 1, wherein a shackle is secured at a position in the body which is above the slot.

9. A car according to claim 8, wherein the shackle is mounted within a recess between projections of the body.

10. A car according to claim 9, wherein means for securing the shackle in position in the body are accessible in a straight line from an end of the body.
